(19) United States
(12) Patent Application Publication
(10) Pub. No.: US 2013/0314523 A1
(43) Pub. Date: Nov. 28, 2013

(54) INVERTED INTERACTIVE COMMUNICATION SYSTEM

(71) Applicant: Joe RUSS, Gravette, AR (US)

(72) Inventor: Joe RUSS, Gravette, AR (US)

(21) Appl. No.: 13/480,016

(22) Filed: May 24, 2012

(51) Int. Cl. H04N 7/18; B32B 37/00

(52) U.S. Cl. 348/77; 428/16; 156/61; 348/E07.085

(57) ABSTRACT

An inverted interactive communication system comprising a user and a face element designed to resemble an inverted partial face with an eye portion and a nose portion above the eye portion, but without a mouth or a chin. The face element may be secured to the user's chin such that the user's mouth is above the nose portion. Thus, the face element and the user's mouth appear to form a complete face when the user is in an inverted position. The system may further comprise an electronic device with a camera, such that the electronic device may capture one or more images of the face element and the user's mouth when the user is in the inverted position and transmit such images to a second electronic device.

### CROSS REFERENCE

Not Applicable.

### BACKGROUND OF THE INVENTION

1. Field of the Invention

This invention relates generally to an inverted interactive communication system, and more particularly, but not by way of limitation, to an inverted partial face that attaches to a user's chin such that the partial face and the user's mouth appear to form a complete face when the user is in an inverted position.

2. Description of the Related Art

Communication via electronic devices has become increasingly popular, including sharing digital photographs and videos via YouTube, Facebook, e-mail, and texting. The universal popularity of handheld devices is having a noticeable adverse effect on the overall population's physical posture. Perhaps most effected is the postural development of growing children.

Based on the foregoing, it is desirable to provide a system of communicating via handheld devices that forces the user to assume a supine or inverted position, which will inadvertently use the force of gravity to stretch and strengthen the antagonist muscles that weaken and shorten in the most common slumped and sitting with head down position.

It is further desirable for such a system to promote the development of the user's proprioception and spatial orientation.

It is further desirable for such a system to promote creative verbal interaction with a handheld device, as opposed to the more common introverted nature of silently participating in using a handheld device.

### SUMMARY OF THE INVENTION

In general, in a first aspect, the invention relates to an inverted interactive communication system comprising a user with a head, where the user's head has a chin and a mouth, and a face element designed to resemble an inverted partial face with an eye portion and a nose portion above the eye portion, but without a mouth or a chin. The face element may be secured to the user's chin such that the user's mouth is above the nose portion. Thus, the face element and the user's mouth appear to form a complete face when the user is in an inverted position. The system may further comprise an electronic device with a camera, such that the electronic device may capture one or more images of the face element and the user's mouth when the user is in the inverted position.

The system may further comprise a connector for securing the face element to the user's chin. The connector may be adhesive, a strap attached to the face element and extending around the user's head, or a pair of ear pieces attached to the face element and extending over the user's ears. Alternately, the system may further comprise a hat worn on the user's head, where the face element is attached to the hat via one or more connectors such that the face element is held in place against the user's chin. The face portion may also have a hair portion below the eye portion.

A method of using the system to communicate while in an inverted position may comprise securing the face element to the user, inverting the user such that the face element and the user's mouth appear to form a complete face, and communicating via the user's mouth such that the face element appears to be communicating. The method may further comprise capturing one or more images of the face element and the user's mouth with an electronic device with a camera. Additionally, the method may further comprise transmitting the one or more images to a second electronic device.

### BRIEF DESCRIPTION OF THE DRAWINGS

FIG. 1 is a front view of the inverted interactive communication system, showing the face portion in place on the user's chin; and

FIG. 2 is a partial front view of the inverted interactive communication system demonstrating the image of a complete face formed by the face portion and the user's mouth.

Other advantages and features will be apparent from the following description and from the claims.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

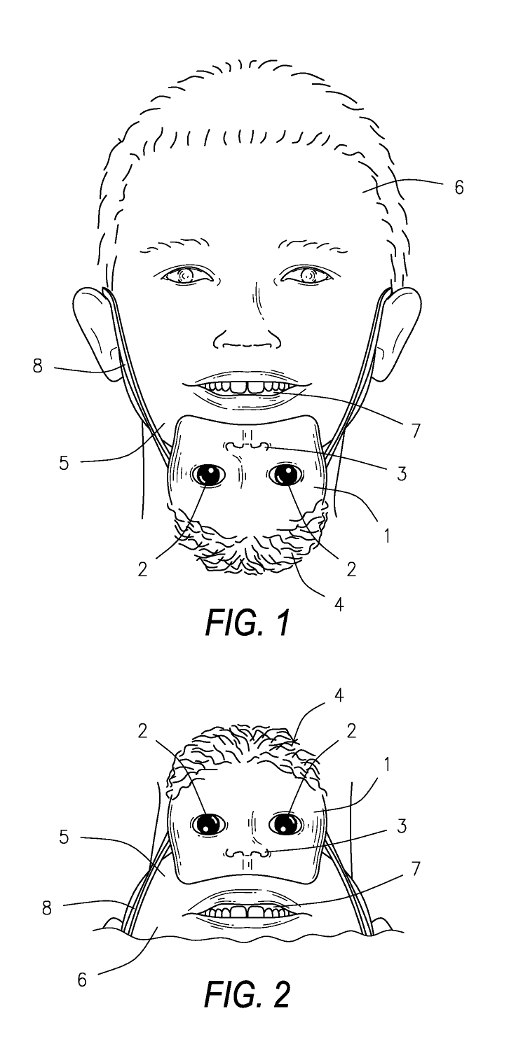

In general, in a first aspect, the invention relates to an inverted communication system, shown in FIG. 1. An inverted face portion 1 may present with any or all aspects of an inverted face except a mouth and chin. In particular, the face portion 1 may have an eye portion with eyes 2 and a nose portion with a nose 3. The eyes 2 may be located below the nose 3, as the face portion 1 is inverted. The face portion 1 may also have hair 4 or other aspects of a head. The face portion 1 may be flat or three dimensional; similarly, the eyes 2, nose 3, and other aspects may be flat images or may be three dimensional.

The face portion 1 may attach to the chin 5 of a user 6. The face portion 1 may be oriented directly below the user's mouth 7, such that the user's mouth 7 appears to be the mouth of the face portion 1 when the user is inverted, as seen in FIG. 2. The face portion 1 may attach to the user 6 via any appropriate method, such as attaching to the user's head via a strap 8 that encircles the user's head or ear pieces that extend over the user's ears, attaching to a hat worn on the user's head, or attaching directly to the user's chin 5 via adhesive.

For the desired effect, the user's face must be in an inverted or upside-down position as viewed from an observer. This gives the impression to the observer that all speech and other oral expression or activity actually coming from the user appears to be coming from the completed face formed by the face portion 1 and the user's mouth 7.

The system may further comprise an electronic device with a camera, allowing the user to take photographs or videos of the completed face formed by the face portion 1 and the user's mouth 7. The user can communicate with other electronic devices through verbal messages, songs, skits, impersonation, and general conversation via the photographs or videos.

While using the system with a handheld mobile device, the user will often assume a posture enabling the user's face to be inverted or upside-down. This position is favorable for improved posture development because it inadvertently uses the force of gravity to stretch and strengthen the antagonist muscles that weaken and shorten in the most common slumped and sitting with head down position. The changes in body position will also promote further development of the user's proprioception and spatial orientation. A more frequent inverted or upside-down position of the user's body engages many physiological responses that would otherwise lose acuity if neglected over time, such as inner ear balance acuity, dilation and contraction of the arteries, and decompression of vertebral discs. Finally, the system will promote creative verbal interaction using the hand held device as opposed to the more common introverted nature of silently participating in using a handheld device.

Whereas, the devices and methods have been described in relation to the drawings and claims, it should be understood that other and further modifications, apart from those shown or suggested herein, may be made within the spirit and scope of this invention.

What is claimed is:

1. An inverted interactive communication system comprising:
a user with a head, where the user's head has a chin and a mouth; and
a face element designed to resemble an inverted partial face with an eye portion and a nose portion above the eye portion, but without a mouth or a chin, where the face element is secured to the user's chin such that the user's mouth is above the nose portion, such that the face element and the user's mouth appear to form a complete face when the user is in an inverted position.

2. The system of claim 1 further comprising an electronic device with a camera, such that the electronic device may capture one or more images of the face element and the user's mouth when the user is in the inverted position.

3. The system of claim 1 further comprising a connector for securing the face element to the user's chin.

4. The system of claim 3 where the connector is adhesive.

5. The system of claim 3 where the connector is a strap attached to the face element and extending around the user's head.

6. The system of claim 3 where the user has ears and where the connector is a pair of ear pieces attached to the face element and extending over the user's ears.

7. The system of claim 1 further comprising a hat worn on the user's head, where the face element is attached to the hat via one or more connectors such that the face element is held in place against the user's chin.

8. The system of claim 1 where the face portion has a hair portion below the eye portion.

9. A method of communicating while in an inverted position, the method comprising:
securing a face element to a user with a mouth and a chin, where the face element is designed to resemble an inverted partial face with an eye portion and a nose portion above the eye portion, but without a mouth or a chin, where the face element is secured to the user's chin such that the user's mouth is above the nose portion;
inverting the user such that the face element and the user's mouth appear to form a complete face; and
communicating via the user's mouth such that the face element appears to be communicating.

10. The method of claim 9 further comprising capturing one or more images of the face element and the user's mouth with an electronic device with a camera.

11. The method of claim 10 further comprising transmitting the one or more images to a second electronic device.
